(19) United States
(12) Patent Application Publication
(10) Pub. No.: US 2006/0174745 A1
(43) Pub. Date: Aug. 10, 2006

(54) Method for coating wire for a musical instrument string, and coated string

(76) Inventor: James D'Addario, Old Westbury, NY (US)

Correspondence Address: ALIX YALE & RISTAS LLP, 750 MAIN STREET, SUITE 1400, HARTFORD, CT, 06103, US

(21) Appl. No.: 11/347,186

(22) Filed: Feb. 3, 2006

Related U.S. Application Data
(60) Provisional application No. 60/651,103, filed on Feb. 8, 2005.

(51) Int. Cl. G10D 3/10

(52) U.S. Cl. 84/297 S

(57) ABSTRACT

A musical instrument string having a tarnish resistant exterior surface, comprising a metal wire at least a portion of which has an ultra-violet (U-V) or electron beam (EB) radiation cured polymeric coating defining the exterior surface and having a coating thickness preferably less than 0.0004 inch (0.4 mil). A method of coating a musical instrument string, and a guitar having such coated strings, are also disclosed.

### RELATED APPLICATION

This application claims the benefit of the filing date of U.S. Application No. 60/651,103 filed Feb. 8, 2005, under 35 U.S.C. §119(e).

### BACKGROUND OF THE INVENTION

The present invention relates to musical instrument strings, and particularly to strings that have a coating, cover or the like to resist surface contamination.

Musical instrument strings, particularly those used on acoustic and amplified musical instruments including classical, steel string acoustic, mandolin, banjo as well as harp and piano have a limited useful life with regard tonal performance. While playing most musical instruments, the musician's hands make contact with the strings. Perspiration and other chemical compounds released by the human body, along with normal atmospheric conditions, cause oxidation and contamination that can quickly deteriorate the tonal qualities and aesthetics of a music string. In some cases, acoustic or classical guitarists will change their strings for every performance in order in maintain the crisp, clear, bright tone of a new string.

Over the years various attempts have been made to minimize or postpone this tonal deterioration. In 1975, David A. Santo introduced the Santo Recording Guitar Strings, which had a thin (1.0 to 1.5 mil) deposit of polytetrafluorethylene (PTFE) fluorocarbon resin (i.e., Teflon brand material) on the surface of both unitary and wound guitar strings. J. D'Addario & Company, Inc. has since 1989 been manufacturing for sale by others such as Vanderbilt Music Company, W&W Harp, and Lyon & Healy, wound harp strings in which the winding wire was precoated with polymeric material, particularly Nylon, before the wire was wound around the core wire. The Fender Corporation has offered wound bass guitar strings that employed a spiral wrap of a flat, relatively stiff polymer tape (such as Nylon) in the nature of a protective sheath. U.S. Pat. Nos. 5,801,319; 5,883,319; 5,907,113; and 6,528,709 (issued to W.L. Gore & Associates, Inc.) describe various embodiments of polymer covers for musical instrument strings, wherein the cover thickness is greater than 0.0004 inch (0.4 mil) and preferably expanded PTFE (e-PTFE). One embodiment associated with FIG. 13 of these Gore patents shows a wound string in which the winding wire has been precoated with a polymer such as polyurethane before wrapping around the core wire.

Since at least as early as 1990, some wound guitar strings have been available commercially, with the wrap wires having been precoated with an extremely thin film of a polymeric material believed to contain polyvinyl chloride (PVC) (e.g., at a thickness of 0.00002 inch, or 0.02 mils), to resist tarnishing.

Japanese published model Patent Application No. 6-50089 (1994) discloses a wound musical instrument string in which the wrap wire was pre-coated with multiple layers of polyurethane.

J. D'Addario & Company, Inc. has marketed the EXP brand of tarnish resistant, coated strings, in which the wrap wire on the wound strings is pre-coated with a thin polyurethane, before winding. The polyurethane was applied in multiple, thin layers to a final coating thickness in the range of about 0.0002 to 0.0003 inch (0.2 to 0.3 mil). Each layer of the coating was a so-called “magnet wire enamel” (ASTM types 1-6) and especially a one component block polyurethane (ASTM type 3), using a solvent based chemistry. The solvent blocks the urethane polymers from curing during application on the wire. The wire is then sent to a curing oven which causes evaporation of the solvent thus allowing the polymers to link and the bond to the wire to be established. This process is not environmentally friendly. The solvent curing process requires catalytic converters to collect the exhaust and slight changes in line speed, oven temperature, solvent concentration can cause improper curing. The process generates offensive odors and requires careful environmental protection measures.

Wires used for music string manufacture have very critical temper specifications. If the temper of the wrap wire is too hard, the string may exhibit a choked sound due to the torsional stiffness in the finished product. If the temper of the wrap wire is too soft the string could exhibit a high level of acoustical damping and be perceived as “dead” and not useful. If too much heat is applied during the curing process, the wire may be over annealed and become too soft causing this “dead” condition.

The heat curing of solvent based chemistry requires extremely tight control over the time and temperature that the coated wire is subject to during the curing process. Too little heat and the solvent does not fully evaporate and cure. The adhesion will then be inadequate and may peel during winding or may create too much acoustical damping, rendering the string “dead” in the ears of the consumer.

Although the EXP strings have achieved their objective and have been commercially successful, the need exists for a simpler, more reliable, and environmentally friendly method for coating musical instrument string wires.

### SUMMARY OF THE INVENTION

It is an object of the present invention to provide a musical instrument string having a tarnish resistant coating such that when new, the coated string exhibits tonal characteristics that closely match the characteristics of the corresponding uncoated string over the full audible range of frequencies including harmonics, and which maintains these tonal characteristics for much longer than the corresponding uncoated string.

It is a more particular object to provide a wound musical instrument string in which the wrap wire has been precoated with a tarnish-resistant material having high adhesion and flexibility, so that the wrap wire can be wound on a core wire using high speed, high tension winding machines, without degrading the exposed coating surface on the finished string.

It is a further object of the invention to provide a process for applying a polymeric coating to a wire for producing a musical instrument string, and the resulting finished string, that is simpler, more reliable, and more environmentally friendly than previously known processes.

These objectives have been achieved in the general sense, by providing a method, and a musical instrument string, in which a polymeric coating of one or multiple layers on a wire, is cured by exposure to ultraviolet (U-V) or electron beam (EB) radiation.

These objectives have been accomplished in a more particular aspect of the invention, by coating various diameters of alloys commonly used for music string manufacture with a U-V or EB radiation curable polymeric material preferably to a final coating thickness of no more than about 0.0004 inch (0.4 mil), especially 0.00015 to 0.00035 inch (0.15 to 0.35 mil), and most preferably in the range of about 0.0002 to 0.0003 inch (0.2 to 0.3 mil).

The coating material is preferably a U-V or EB curable coating selected from one of the following chemistries: silicone acrylate, urethane acrylate, epoxy acrylate, polyester acrylate, vinyl ethers and cationic cure epoxides.

The method is suitable for unitary strings (such as the top two or three strings on a guitar), but is particularly effective for wound strings, such as the bottom three or four strings on a guitar. For wound strings, the method preferably comprises the steps of selecting a first, metal or polymeric core wire; selecting a second, metal wire for winding around the core wire; before winding the second wire around the first wire, coating at least a portion of the second wire with a single or multiple layers of U-V or EB curable polymeric material to a total cured coating thickness of less than about 0.0004 inch (0.4 mil), preferably 0.00015 to 0.00035 inch (0.15 to 0.35 mil), and most preferably in the range of about 0.0002 to 0.0003 inch (0.2 to 0.3 mil); and winding the coated second wire around the first wire in a tight spiral to form a wound string wherein the second wire defines the outer surface of the wound string.

Advantageously, the coating of at least a portion of the second wire comprises an evenly applied layer of U-V or EB cured material having a total thickness not greater than 0.0004″ and preferably 0.00015 to 0.00035″ and most preferably in the range of 0.00020-0.00025″. The coating is applied by dipping the wire followed by either wiping with a flexible pad material under pressure or passing through a die with an O.D. that is 0.0002-0.0004 larger than the actual diameter of the uncoated wire. The wire can be successfully coated in one dipping pass or in multiple passes of smaller thicknesses. In the flexible pad application method the wire can be dipped to apply the coating or the coating can be applied by the flexible pad.

The very thin first coating layer helps the polymer adhere strongly to the raw wire, thereby resisting chipping or delamination, while providing the flexibility needed for high speed, high tension winding. The subsequent layers bond essentially seamlessly to the respective preceding layer, effectively forming a homogenous coating without discernable discontinuities or delineations between the layers. An indication of both high adhesion and flexibility is that a properly formed cured coating on a given wire will withstand wrapping around a mandrel, which can be as small as the wire itself, and having no cracking, peeling, blistering, flaking, or delamination.

The invention is suitable for use with a variety of wire gauges and shapes for unitary strings and for the winding wire of wound strings. Strings made in accordance with the invention can be used for both fretted and non-fretted instruments, including pianos, but the invention finds particular efficacy for guitars and the like where the fingers repeatedly contact particular regions of the string. The coating can be applied to any raw wire suitable for winding musical instrument strings. Typical materials include any copper based alloy, phosphor bronze, 80/20 brass, 85/15 bronze, as well as silver plated copper, stainless steel, monel, and nickel-plated steel.

The U-V process can fully cure the coating at much higher line speeds and with much more reliability than the conventional heat curing processes. For example the current heat curing process runs at approximately 10 meters per minute and the U-V process has been successfully run at 800 meters per minute. There is a significant savings in labor and energy consumption. At these speeds the U-V light imparts considerably less heat into the wire. The U-V process also allows for constant stopping and starting of the production line with minimal run up waste. The heat cured process requires that hundreds of feet of wire be run through before it stabilizes and product quality is acceptable. This creates tremendous waste and difficulty in marking and identifying that waste.

### BRIEF DESCRIPTION OF THE DRAWINGS

The invention will be described in greater detail with reference to the accompanying drawings, in which:

FIG. 1 is an illustrative view of a unitary musical instrument string having a coating according to the present invention;

FIG. 2 is an illustrative view of a wound musical instrument string having a precoated winding wire in accordance with the preferred embodiment of the invention;

FIG. 3 is an illustration of a guitar with mounted strings according to the invention.

### DESCRIPTION OF THE PREFERRED EMBODIMENT

The preferred embodiment of the invention is implemented with a one-component, U-V or EB-cured, blocked (ASTM Type 3) formulation, optionally applied in multiple layers. The single or each coating layer is preferably applied in a continuous running process where a long length or strand of wire is dipped into the liquid coating material, then wiped with felts or metering dies that define a die channel just slightly larger than the outside diameter of the wire itself. Quality music strings are very symmetric, and this is achieved with the present invention by use of dies through which the coated wire passes vertically.

The wire with the sized, pre-cured coating material is passed through a U-V or EB chamber for curing. Each coating layer is applied isotropically, i.e., the coating step itself produces no preferential orientation of molecules, ligaments, strands, or the like. The first or primary layer is applied to a raw wire (i.e., clean, bare, plated or unplated metal). The foregoing steps are performed on a long strand that when completed is spooled, typically for shipment to a string fabricator. A wound string would then be completed by feeding the coated wire from the spool to a music string winding machine.

This process may be repeated multiple times (e.g., at least two, and preferably six to eight or more) depending on the wire size and the alloy type. After each coating layer is applied, the wire is wiped with a sizing die and cured. The finish is hard (abrasion resistant) but the coating is not brittle, i.e., it is flexible enough resist cracking or peeling during the winding process or while a musician plays the strings on a guitar (e.g., strumming, picking, fretting, etc.) The coating thickness is most preferably in the range of 0.0002 to 0.00003 inch (0.2 to 0.3 mils) but a useful range is 0.00015 to 0.00035 inch (0.15 to 0.35 mils).

Due to the thin, hard coating the resultant strings show minimally diminished tonal characteristics that last three to five times longer than comparable uncoated strings.

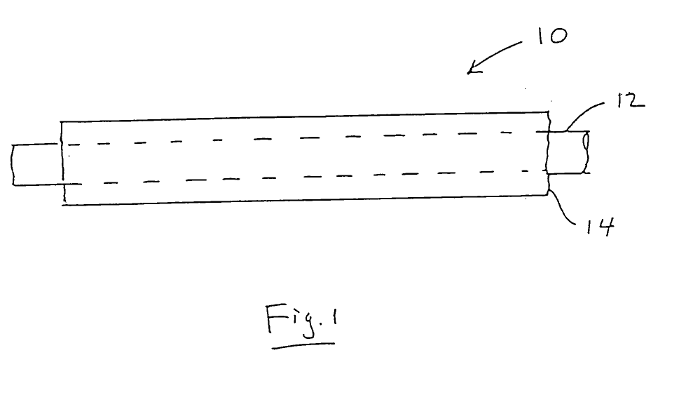

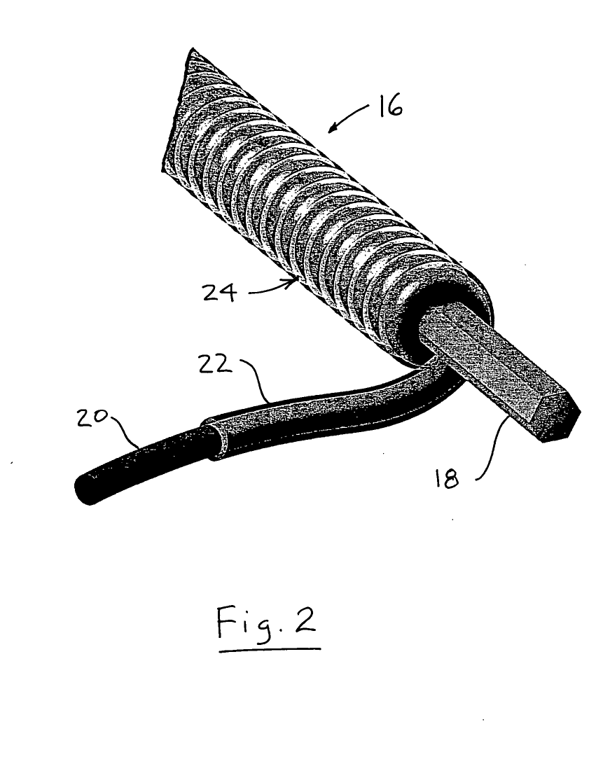

FIG. 1 shows a unitary string 10 such as one of the top two or three strings of a guitar, having a tin or brass plated high carbon steel alloy or stainless steel alloy wire 12 of thickness in the range of 0.007 to 0.026 inch (7 to 26 mils), with a hard polyurethane coating 14 of thickness in the range of 0.2 to 0.4 mils according to the invention. FIG. 2 shows a wound string 16 such as one of the bottom three or four strings of a guitar, having an hexagonal steel core wire 18 of thickness in the range of 0.010 to 0.026 inch (10 to 26 mil), and a pre-coated wrap wire 20 of phosphor bronze alloy or other material such as brass cooper silver-plated copper, nickel-plated steel, etc., having a thickness in the range of 0.004 to 0.028 inch (4 to 28 mil) and a hard polyurethane coating 22 thereon of 0.25 mil nominal thickness. The wrap wire forms a tight spiral 24 around the core wire 18.

Single or multi-layer polymer coatings have been used for a number of years to provide a thin insulating film on silver or copper wire for use in speakers and other electrical/electronic components. Polymer coatings have also been applied to string or strand material, for example, on strings for tennis rackets. Also, polymer coatings have been applied to fiber optic cables. Ultraviolet or electron beam-curable polymeric materials are known in that context. Accordingly, such polymeric formulations, application techniques, curing techniques, and associated processing equipment, are well known. Examples may be found in U.S. Pat. Nos. 6,528,553, 6,716,892, 6,075,065, 4,424,252, 4,812,489, 6,759,664, 6,825,243, and 3,925,671, the disclosures of which are hereby incorporated by reference. In contrast, strings coated according to the present invention are subject to mechanical vibration of the string, mechanical impact from vigorous contact with a pick, and chemical reaction from contact with skin. In addition, stresses are imposed during high tension, high-speed winding. As used herein, high speed winding means at a rate exceeding 18,000 RPM, especially exceeding 20,000 RPM. High tension means in the range of about 6,000-54,000 psi, especially about 8,000 to 25, 000 for guitar strings. None of these stresses is present where magnet wire and the like are conventionally used.

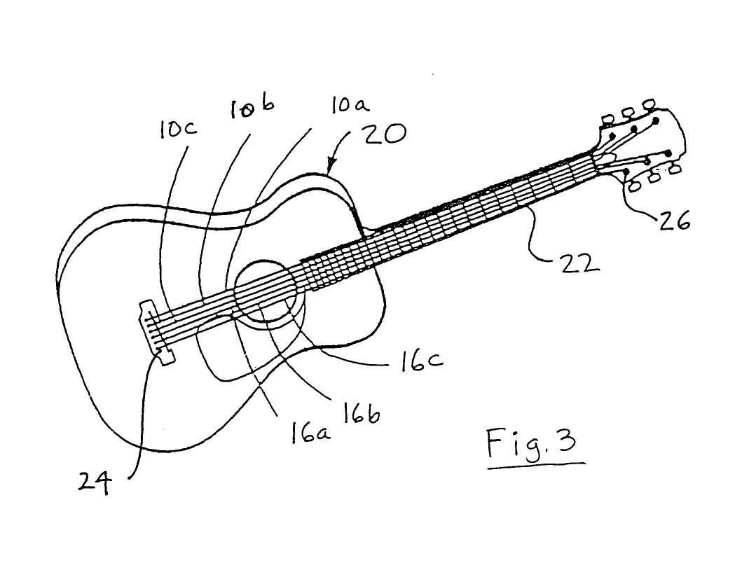

FIG. 3 illustrates a guitar 20 having three unitary strings 10a, 10b, and 10c and three wound strings 16a, 16b, and 16 according to the invention, mounted to the guitar along a fret board 22 with ends 24, 26, adapted to be secured for mutual spacing and individual tensioning of the strings. One or both ends can be either cut clean or fitted with a stop or the like, as is well known. An entire string according to the invention, would normally be coated over its full speaking length. However, the coating could under some circumstances extend only along a portion or portions, e.g., excluding regions near the ends of the strings.

1. A musical instrument string having an exposed surface of U-V or EB cured polymeric material.

2. The musical instrument string of claim 1, wherein the string is a wound string having a core and a winding wire wrapped around the core and said exposed surface is defined by polymeric material adhered to the winding wire.

3. The musical instrument string of claim 1, wherein the string is a wound string having a core and a winding wire wrapped around the core and said exposed surface is defined by a polymeric material applied around and U-V or EB cured on the winding wire before the winding wire was wrapped around the core.

4. The musical instrument string of claim 2, wherein the polymeric material is a multi-layered coating.

5. The musical instrument of claim 1, wherein the string is mounted to a stringed instrument which defines a string speaking length and the cured polymeric material extends along the entire speaking length.

6. The musical instrument string of claim 5, wherein the polymeric material has a substantially uniform thickness of less than about 0.0004 inch (0.4 mil).

7. The musical instrument string of claim 1, wherein the polymeric material is selected from the group consisting of silicone acrylate, urethane acrylate, epoxy acrylate, polyester acrylate, vinyl ethers, and cationic cured epoxides

8. The musical instrument string of claim 2, wherein the polymeric material is selected from the group consisting of silicone acrylate, urethane acrylate, epoxy acrylate, polyester acrylate, vinyl ethers, and cationic cured epoxides.

9. The musical instrument string of claim 3, wherein the polymeric material is selected from the group consisting of silicone acrylate, urethane acrylate, epoxy acrylate, polyester acrylate, vinyl ethers, and cationic cured epoxides.

10. The musical instrument string of claim 6, wherein the polymeric material is selected from the group consisting of silicone acrylate, urethane acrylate, epoxy acrylate, polyester acrylate, vinyl ethers, and cationic cured epoxides.

11. The musical instrument string of claim 7, wherein said coating has a substantially uniform thickness of less than 0.0004 inch (0.4 mil).

12. The musical instrument string of claim 11, wherein the coating has multiple layers and each layer has a thickness of no greater than about 0.0001 inch (0.1 mil).

13. The musical instrument string of claim 11, wherein the string has a core and a winding wire wrapped around the core and the winding wire comprises said coated metal wire.

14. The musical instrument string of claim 13, wherein the core wire has an hexagonal cross section with an effective diameter in the range of 0.010 to 0.026 inch (10 to 26 mils), the winding wire is round and has a diameter in the range of 0.004 to 0.028 inch (4 to 28 mils), and the coating has a thickness in the range of 0.00015 to 0.00035 inch (0.15 to 0.35 mil).

15. The musical instrument string of claim 1, wherein the string has a core and a winding wire wrapped around the core, the winding wire comprises said coated metal wire, and the winding wire is selected from the group of materials consisting of copper based alloys, phosphor bronze, 80/20 brass, 85/15 bronze, silver plated copper, stainless steel, monel, brass, and nickel-plated steel.

16. The musical instrument string of claim 15, wherein the coating has a thickness in the range of about 0.0002 to 0.0003 inch (0.2 to 0.3 mil).

17. The musical instrument string of claim 16, wherein the coating thickness varies by no more than about 0.00005 inch (0.05 mil).

18. A method for fabricating a tarnish resistant wound musical instrument string comprising:
selecting a clean metal wire;
coating the clean metal wire with a layer of a U-V or EB curable polymeric material;
U-V or EB curing the coating to form a coated wire; and
winding the coated and cured wire around a core wire to produce said tarnish resistant wound instrument string.

19. The method of claim 18, wherein the coating and curing are performed on a long strand that when completed is spooled, and the winding is performed by feeding coated wire from said spool to a music string winding machine.

20. The method of claim 18, wherein the coated wire is passed through a vertical die before curing.

21. The method of claim 18, wherein the polymeric material is selected from the group consisting of silicone acrylate, urethane acrylate, epoxy acrylate, polyester acrylate, vinyl ethers, and cationic cured epoxides.

22. A guitar having at least one wound string with opposed ends mounted on the guitar, said wound string between said ends consisting essentially of a core wire and a winding wire wrapped around the core wire, the winding wire comprising a metal wire having a U-V or EB cured polymer coating defining a tarnish resistant exterior surface of the string.

23. The guitar of claim 22, wherein said coating has at least one layer of a U-V or EB cured coating that forms a total coating thickness in the range of 0.0002 to 0.0003 inch (0.2 to 0.3 mils).

24. The guitar of claim 22, wherein the polymeric coating is selected from the group consisting of silicone acrylate, urethane acrylate, epoxy acrylate, polyester acrylate, vinyl ethers, and cationic cured epoxides.
